(19) United States
(12) Patent Application Publication
(10) Pub. No.: US 2017/0211240 A1
(43) Pub. Date: Jul. 27, 2017

(54) STRUCTURING ELEMENTS FOR ROAD SURFACES, USE THEREOF AND METHOD FOR PRODUCING ROAD SURFACES

(71) Applicant: HEIDELBERGCEMENT AG, Heidelberg (DE)

(72) Inventors: Siegfried RIFFEL, Talheim (DE); Juergen SCHMIDT, Celle (DE)

(73) Assignee: HEIDELBERGCEMENT AG, Heidelberg (DE)

(21) Appl. No.: 15/328,964

(22) PCT Filed: Jul. 24, 2015
(86) PCT No.: PCT/EP2015/001533

§ 371 Date: Jan. 25, 2017

(30) Foreign Application Priority Data
Jul. 25, 2014 (EP) 14002585.9

(51) Int. Cl. E01C 11/24; C04B 14/04; C04B 28/02; E01C 7/35; E01C 11/00

(52) U.S. Cl. CPC E01C 11/24; E01C 7/35; E01C 11/005; C04B 28/02; C04B 14/04; C04B 2111/0075

(57) ABSTRACT

The invention relates to texturizing elements for sanding or blunting traffic surfaces, said elements having a tetrahedral basic shape having a distance between two corner points of 2 to 10 mm, wherein the texturizing elements have surfaces that are bent to be concave having a ratio of arching height to distance between two corner points ranging from 0.05 to 0.35, and a compressive strength of at least 120 MPa according to DIN EN 196-1. The invention furthermore relates to a method for producing or restoring traffic surfaces, in which the texturizing elements are sanded on the still plastic cover layer and are rolled in, impressed or rubbed into it, and the use of the texturizing elements for sanding or blunting traffic surfaces.

The present invention relates to texturizing elements for traffic surfaces.

The construction of traffic surfaces, in particular roads and paths, is necessary because naturally grown ground does not meet the requirements of modern traffic and transport systems. One of the aims of the road construction system is to create durable and secure traffic surfaces that, at the same time, are as sustainable and economical as possible. The construction techniques and construction methods are continuously further developed or optimised in order to meet the increasing demands with regards to quality, economy and traffic security. In particular, the protection of people and the environment have become significantly more important and require new solution processes in the construction of roads and paths.

One aspect that has significantly increased in importance is noise insulation. Because roads are the most prevalent traffic surface, road traffic noise (also road noise for short) above all plays a large role. All the noise produced by road traffic is labelled as road traffic noise. These are, above all, the sounds produced passenger vehicles and lorries and motorised bicycles. Sound arises from engine sounds, rolling noises from tyres and the air vortices that arise on the bodywork and attachment parts at high speeds, among other things.

Engine noises arise from the operation of the motor, gearbox and drive train of a motor vehicle and their auxiliary aggregates and attachment parts. Engine sounds are transferred as airborne and structureborne sound into the interior of the vehicle and outwards and dominate the produced noise—depending on the motor vehicle class and type of engine—at low speeds and high engine output, such as in city traffic or when starting the vehicle. Reducing these is a matter for motor vehicle manufacturers, like minimising the air vortex at high speeds.

In comparison, the roll sounds from tyres are greatly influenced by the roadway. The treads and the carcase are shifted in oscillations by the roughness of the roadway and the friction profile and and emit airborne sound. Furthermore, air in the tyre tread is displaced in the inlet and then again sucked in in the outlet. As a result of this, aerodynamic sounds emerge (so-called airpumping). Tyre-roadway sounds are dominant over a wide speed range (from around 30-50 km/h, according to gear selection). They occur particularly e.g. on natural stone paving with a rough surface and wide joints and with lorries.

Thus, it is a constant object to provide traffic surfaces that produce less noise, wherein economy and durability should, of course, not be neglected.

Roads and paths are made of different materials such as asphalt, concrete, pavement or out of a loose material (gravel, for example). There are already many suggestions for noise-reducing traffic surfaces, of which some of them are also used in practice. An overview can be found, for example, at http://www.umweltbundesamt.de/publikationen/laermmindernde-fahrbahnbelaege-0, ISSN 1862-4804.

It is known from DE 35 24 661 A1 to apply particles with glass beads on the surface onto a coating. By doing so, reflective markings are to be created. The preferably tetrahedral particles should be fixed with the tip facing upwards in order to obtain as high a reflection as possible. FR 2160899 A1 suggests installing tetrahedral particles with a tip or edge pointing upwards to increase the grip of roadway coatings. In both case, no noise reduction can be expected because of the low targeted surface, on the contrary, in comparison to the usual sanding grit, an increase of noise has to be expected.

Surprisingly, it has now been found that, with traffic surfaces that are sanded or textured, a defined shaped texturizing agent can reduce the noise production, wherein the traffic surfaces are, at the same time, durable and economical.

The invention thus solves the above object with texturizing elements having a tetrahedral basic shape having a distance between two corner points of 2 to 10 mm, wherein the texturizing elements have surfaces that are arched with an arching height of 5 to 35% of the distance between two corner points, and wherein the texturizing elements have a compressive strength of 120 to 180 MPa determined according to DIN EN 196-1. The object is furthermore solved by using the texturizing elements to sand traffic surfaces and by a method for producing traffic surfaces, in which the texturizing elements are rolled into, impressed or rubbed into the still plastic surface of the traffic surface.

In many embodiments, asphalt streets are sanded with natural, broken aggregate (so-called grit) or with industrially produced aggregate (e.g. synthetic hard substances, bauxite, corundum, chrome ore slag) during the manufacturing process, wherein the grit scattered in abundance is rolled into the hot asphalt cover layer. Grain of 1/2, 1/3, 2/3, 3/4, 2/5, 4/8, 5/8 or 8/11 are therein used as delivery grain sizes, wherein the grit and hard substances may contain a not insignificant number of oversize and undersize, according to the technical codes (in Germany, for example, a maximum of 10 or 15 wt % undersize and a maximum of 10 wt % oversize). Only high-quality, broken aggregate, so-called grit, should be used for a permanently non-slip and low-noise roadway surface, said aggregate meeting the high demands for sanding material in terms of compressive strength, polishing and attrition resistance grain shape, angularity, flakiness, grading curve affinity etc. Because of the particular technical requirements and the expensive preparation this grit or hard substance is expensive and in many regions also only available to a limited extent.

The grip and the noise reduction of roadway surfaces are thereby decidedly influenced by the shape of the grains and the flakiness of the broken aggregate. In practice, it turns out that, often, the demands for the grip and noise reduction are not able to be achieved because of the permissible tolerance of unfavourably shaped or flaked grains 15 wt %, SI₁₅ and FI₁₅ category). Here, the invention provides remedy.

The ideal concept of low-noise surfaces consists of plateaus and ravines. The plateaus should thereby be as much at the same height as possible in order to provide a maximum number of supporting plateaus on the same level to the tyres. Thus, the deformation of the tyres significantly responsible for the rolling noises is minimised. The ravines between the supporting plateaus facilitate the dissipation of the air between tyre and roadway surface, and thus reduce or prevent aero-acoustic crimping sounds (air pumping) from arising.

The tetrahedral shape chosen according to the invention provides a large supporting plateau with every partial surface. Since all tetrahedral surfaces are the same, it is insignificant, which is pointing upwards. Theoretically, the whole surface could be coated covered by equilateral triangles such that the requirement for an even construction of the roadway surface is met. On the other hand, the tetrahedral shape ensures that when rolling in, impressing or rubbing in the texturizing elements, a surface is always pointing upwards. The penetration force is smallest for the tips such that texturizing elements that have a surface lying downwards are aligned with a surface facing upwards when rolling in, impressing or rubbing in. Since the penetration force increases linearly with increasing penetration depth, all the texturizing elements are substantially rolled in, impressed or rubbed in to the same depth.

The preferably provided curvature of the surfaces/edges has the effect that the texturizing elements are evenly distributed by rolling when rolling in, impressing or rubbing in similar to spheres, which would be optimal in this respect. Thus, a compromise is made between good distribution ability by rolling and the presence of as flat a surface as possible as a supporting plateau. Generally, larger texturizing elements have more prominent protrusion. The rounded edges also contribute to the texturizing elements producing less attrition during handling, which could impair the adhesion or the bond.

Suitable arching results with a ratio of arching height to distance between two corner points (edge length of the tetrahedron without arching) ranging from 0.05 to 0.35, preferably 0.10 to 0.30 and particularly preferred 0.15 to 0.25. The largest distance between arched surfaces and the plane is labelled as arching height, said plane being defined by the three corners of the related surface. Naturally, the shape may be slightly irregular, the edge does not have to correspond to an arc and the surface to a spherical segment. It is however preferable if the deviations are not great so that the rolling characteristics are good.

The distances between two corner points, i.e. the edge lengths of the non-arched tetrahedron, should range from 2 to 10 mm, preferably range from 3 to 8 mm and particularly preferred range from 4 to 6 mm, wherein all the texturizing elements have substantially the same edge length and all the edge lengths of a texturizing element are substantially equally long. Substantially equally long and substantially the same edge length means that the differences may not compromise the alignment ability and the same height after rolling in, impressing or rubbing in. It is expected that tolerances induced by the manufacturing of a maximum of 10%, preferably a maximum of 5%, in particular a maximum of 2% of the edge length or up to 1 mm, preferably up to 0.5 mm, and in particular up to 0.2 mm are harmless.

In order to achieve the desired compressive strengths, the texturizing elements are produced out of materials which have these properties.

A first preferred material is concrete, in particular “reaction powder concrete”, RPC for short, or “ultra high performance concrete”, UHPC for short. Suitably, a corresponding cement, e.g. a CEM I 52.5 R is mixed with stone flour, e.g. quartz flour, as aggregate, and water and left to harden in moulds of the desired shape and size. Generally, plasticizer is necessary and contained.

The moulds can advantageously obtain a micro-roughness by means of sanding with highly wear resistant aggregate mechanical treatment and/or chemical treatment such that the texturizing elements have a good and durable grip because of the micro-roughness. Natural sands, e.g. bauxite, flint, corundum, garnet and industrially manufactured aggregate, for example, synthetic aluminium oxide, chrome ore slag, silicon carbide, chromium (III) oxide, zirconium (IV) oxide or similar are suitable as high strength aggregate, so-called fine sand. The grain sizes are suitably from 20 to 160 μm. The produced micro-roughness preferably amounts to 0.063 to 0.2 mm.

Monobloc moulds can also be used for texturizing elements with a small arching height. In order to generate a micro-roughness in this case, it is suggested to sand the layers forming the surface in the mould with a highly wear-resistant fine sand after smoothing.

Furthermore, it is possible to provide the texturizing elements on the surfaces with photocatalytically active material (e.g. nano-titanium dioxide) or to produce texturizing elements out of a photocatalytically active concrete (e.g. based on TioCem® that is available from HeidelbergCement AG). Thus, on the one hand, self-cleaning properties are obtained and, on the other hand, the roadway surface can contribute to the depletion of air pollutants (e.g. nitrous gases NO_{R}).

A typical RPC formulation comprises:

500-1000 kg/m³ cement, 1500-2000 kg/m³ stone flour and 125-200 kg/m³ water (water cement value (w/z) 0.25-0.35 or water binder value (w/b) 0.15-0.25). Suitably, 25-100 kg/m³ silica dust, or silica slurry, are also added, and/or 3-6 wt. % plasticizer, based on the cement mass. Typical fresh concrete bulk densities range from 2400 to 2600 kg/m³.

A second preferred material for the texturizing elements is ceramic. Suitable inorganic raw materials such as clay for example are mixed to a paste with water, placed in the mould, dried as green bodies and sintered. In doing so, the surface can also be supplied with the micro-roughness described above.

The texturizing elements can also be produced as pellets in corresponding moulds by means of hydraulic presses. To this end, the earth-moist RPC material mixture is formed into the corresponding shape of the texturizing element under hydraulic pressure in a radial runout mould body press in a special pellet formwork. The fresh pellets have such a high strength that they can be received by a transport belt without being damaged and directly further transported on this into a moist or mist curing chamber. The moisture necessary for complete hydration is supplied to the texturizing elements in the moist or mist curing chamber such that 100% of the high final strength is achieved.

From a technical perspective, the texturizing elements could also be obtained with suitable mechanical properties by erosive processing of solid bodies. This is, however, not economical according to the current state of knowledge.

The compressive strength of the texturizing elements is at least 120 MPa, preferably at least 130 MPa, in particular at least 150 MPa. The compressive strength is determined according to DIN EN 196-1. An upper limit is not implied by the purpose, however, values above 180 MPa have no advantage according to current knowledge.

Preferably, the texturizing elements have a frost and frost de-icing salt resistance, checked according to DIN CEN/TS 12390-9, with a weathering of at most 1.5 kg/m², preferably at most 0.5 kg/m² and in particular at most 0.05 kg/m². It is expected for the RPC of the texturizing elements that there is no weathering because of the high density and strength of the concrete and the low water cement value. Weathering values below 0.03 kg/m² are not necessary according to current knowledge.

Preferably, the texturizing elements have a polishing resistance (so-called PSV value), measured according to DIN EN 1097-8, of at least 53, preferably at least 55 and, in particular, at least of 58. Here there is also no upper limit in principle, but values above 62 are not necessary according to current knowledge.

The production of traffic surfaces takes place in a way known as such wherein at first a supporting layer and, as the case may be, a binding layer is produced. The cover layer is applied on these and is sanded with the texturizing elements according to the invention. While the cover layer is still plastic, the texturizing elements are rolled in, impressed or rubbed in. Since they have no preferred direction, substantially flat surfaces emerge when rolling in. Because of the very high shape factor, a reduced distortion of the tyres can be expected during rolling. The slightly rounded edges ensure that the texturizing elements do not become entangled during sanding and are evenly distributed across the surface. The term production of traffic surfaces, in the scope of the present invention, also comprises restoring traffic surfaces when at least the cover layer is renewed.

Above all, hot rolled asphalt (e.g. asphalt mastic, gravel mastic asphalt, asphalt concrete) and poured asphalt are considered as cover layers, which are essentially blunted or sanded because of established grip requirements.

But roadway covers made of concrete can also produced or supplied to be permanently non-slip and noise-reducing by means of the texturizing elements. In comparison to the washed concrete construction method using natural, relatively irregular broken aggregate, an uniform surface texture with regard to the durability, grip, noise reduction, driving dynamic and driving comfort can be produced by the texturizing elements optimised in terms of shape, form and material quality.

Furthermore, traffic surfaces made of concrete pre-assembled components, for example according to DE 10 2007 040 245 A1, can also be supplied with the texturizing elements.

In yet another variant, the texturizing elements can be provided fixed to a carrier, for example on a mat, a grate, a non-woven, a film, a knitted fabric, a fabric and others. This carrier can be flexible and inserted into a still fresh, i.e. not yet hardened surface. It can be a rigid carrier that forms the uppermost layer of the traffic surface. The material for the carrier depends on whether it is embedded or forms the uppermost layer. Carriers that form the uppermost layer can consist of concrete, asphalt, artificial resin or steel for example. Carriers that are inserted into the uppermost layer of the traffic surface can consist of glass, plastic, textile or carbon for example. Most simply, the carriers are fixed by being inserted into or applied on the fresh cover layer when the cover layer is hardening. Adhesive bonding is also possible. It should be understood that the carriers are installed in such a way that they form a closed surface. Anchoring elements can be provided on the underside of the carriers and/or connection agents on the edges.

The texturizing elements are also suitable for surfaces based on epoxy or polyurethane resin. In doing so, they are scattered on the freshly applied resin coating and preferably also rolled in, impressed or rubbed in.

The invention will be explained by means of the following examples and the attached figures, without, however, being limited to the specially described embodiments. Unless otherwise stated or the context suggests otherwise, the percentages relate to weight, in case of doubt to the total weight of the mixture.

The invention also relates to all combinations of preferable embodiments, if these are not mutually exclusive. The terms “about” or “approx.” in connection to a number mean that values at least about 10% higher or lower or values about 5% higher or lower and in any case about 1% higher or lower are included.

Here are shown:

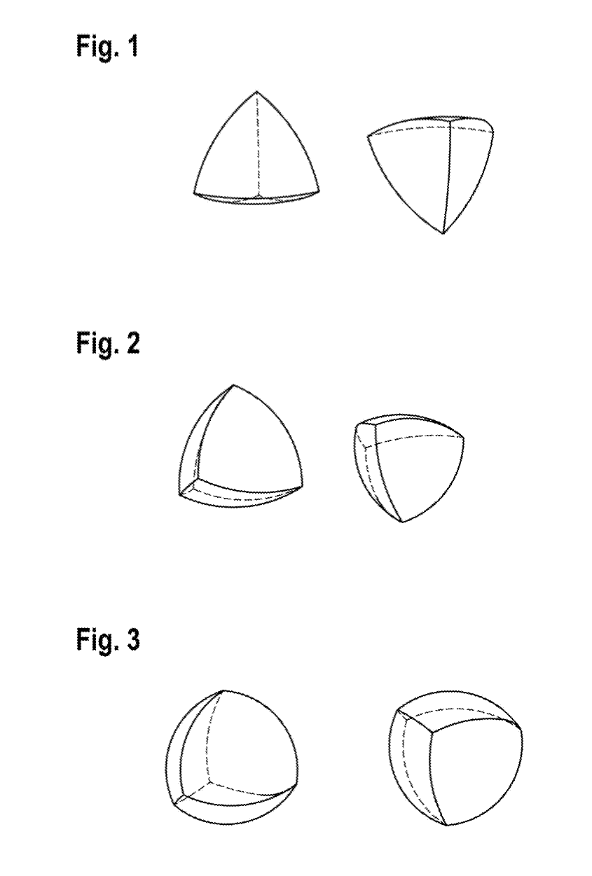

in FIG. 1, a first texturizing element

in FIG. 2, a second texturizing element

in FIG. 3, a third texturizing element

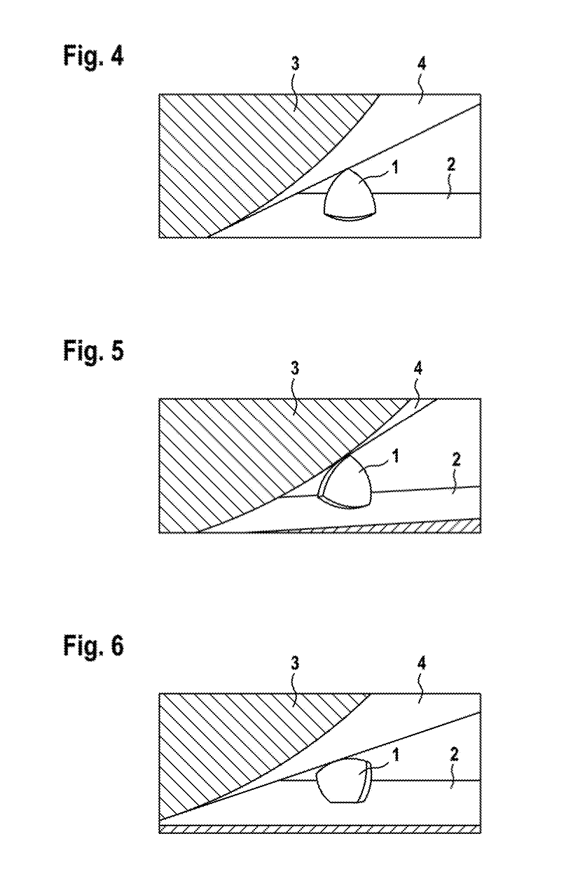

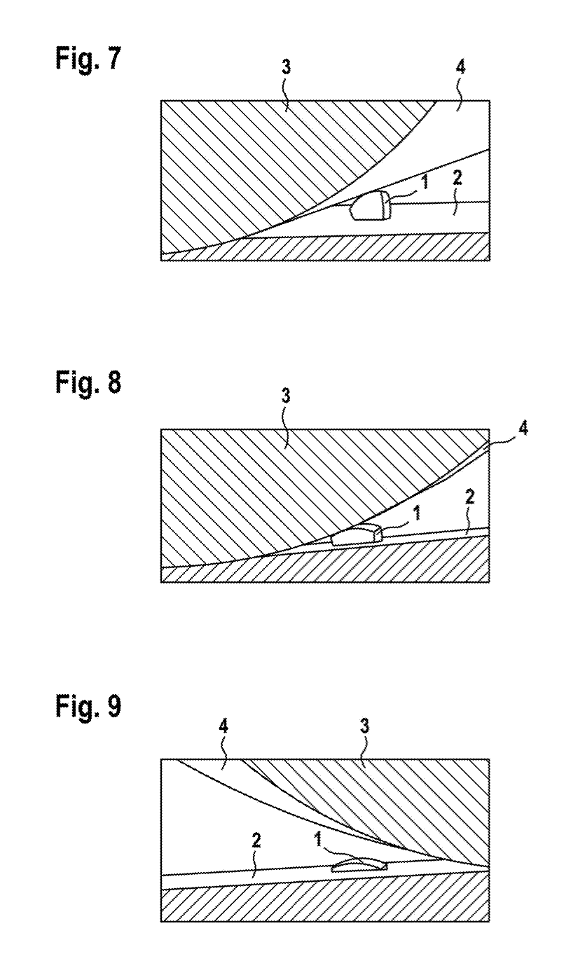

in FIG. 4-9 a rolling in procedure.

In FIGS. 1 to 3, texturizing elements are perspectively depicted, in each case once with a tip facing up and once with a tip facing down. The texturizing elements have different arching heights. In FIG. 1, the arching height is 10%, in FIG. 2 it is 20% and in FIG. 3 it is 30%. In the direct comparison, it can be easily recognised how the increasing arching height makes the texturizing elements more spherical in the outer shape. Nevertheless, the arched surfaces remain so flat that they offer the tyres a flat support that keeps the deformation of the tyre small.

In FIGS. 4 to 9, the rolling in procedure is schematically depicted by means of one single texturizing element. In FIG. 4, the moment is shown in which the texturizing element 1 just comes into contact with the surface of the coating 2 and the roller 3, i.e. the rolling surface 4 of the roller 3. The size ratio of texturizing element 1 and roller 3 are not true to scale. During further rolling of the roller 3, the surface 4 thereof exerts pressure on the texturizing element 1 to which this succumbs by penetrating its front, lower tip or edge into the still plastic coating 2. Since the force of the penetration of the tip or edge is smaller than the force for the penetration of the contact surface, the texturizing element 1 aligns itself with the tip facing downwards when rolling in. As shown in FIGS. 6 to 8, it is pressed further and further in by the rolling surface 4 of the roller 3. When the roller 3 is finally rolled away across the texturizing element 1, as shown in FIG. 9, the surface thereof is substantially on a level with the surface of the coating 2. According to the ratio of weight strength of the roller 3 and plasticity of the coating 2, it does not protrude out of the coating 2 at all or only protrudes with (in arched elements 1 with the centre) its surface or sticks up somewhat—as shown in an exaggerated manner in FIG. 9.

### EXAMPLE 1

A concrete (so-called RPC) was produced with a bulk density of 2540 kg/m³ out of 600 kg/m³ cement, 1800 kg/m³ quartz flour with grain sizes ranging from 0.04 to 0.5 mm, silica dust (16 wt % in terms of the cement), 172 kg/m³ water (water cement value 0.35, water binder value 0.25) and 38 kg/m³ plasticizer (5 wt % in terms of the cement). The flow spread was 630 mm. The compression strength and bending tensile strength of the RPC were determined according to DIN EN 196-1 on prismatic test bodies (so-called mortar prisms) with a cross section of 40 mm×40 mm and a length of 160 mm. In addition, the RPC was poured into the test body mould according to DIN EN 196-1, was solidified on the vibrating table and subsequently succintly smoothed. The test bodies in the mould were covered with a glass plate and subsequently stored in a moisture room (temperature 20.0° C.±1.0° C., relative air moisture >90%) until demoulding after 24 hours. Immediately after demoulding, the test bodies were stored in a moist towel (check after 24 hours) or in a water bath with a temperature of 20.0° C.±1.0° C. until the respective check after 1, 7 and 28 days. Initially, the bending tensile strength was determined on the prisms according to DIN EN 196-1 and subsequently the compressive strength on the prism halves. The results are summarised in Table 1.

TABLE 1

| | Check age | | |
|---|---|---|---|
| | 1 d | 7 d | 28 d |
| Compressive strength | 25.9 MPa | 95.9 MPa | 150.3 MPa |
| Bending tensile strength | 5.0 MPa | 18.7 MPa | 22.0 MPa |

### REFERENCE NUMBER LIST

1 Texturizing element
2 Coating
3 Roller
4 Roller surface

1-20. (canceled)

21. Texturizing element for sanding or blunting traffic surfaces having a tetrahedral basic shape having a distance between two corner points of 2 to 10 mm, wherein surfaces of the texturizing element are bent to be concave having a ratio of arching height to distance between two corner points ranging from 0.05 to 0.35, and wherein the texturizing element has a compressive strength of ≦120 MPa determined according to DIN EN 196-1.

22. Texturizing element according to claim 21, wherein the distance between two corner points ranges from 3 to 8 mm.

23. Texturizing element according to claim 21, wherein the ratio of arching height to distance between the two corner points ranges from 0.05 to 0.30.

24. Texturizing element according to claim 21, wherein the surfaces have a micro-roughness.

25. Texturizing element according to claim 21, wherein the texturizing element consists of high strength mortar or high strength fine grained concrete.

26. Texturizing element according to claim 25, wherein the mortar or concrete is produced from 500-1000 kg/m³ cement, 1500-2000 kg/m³ rock flour and 125-200 kg/m³ water, with a water cement value from 0.25 to 0.36, and a water binder value from 0.15 to 0.25.

27. Texturizing element according to claim 26, wherein, additionally, one or several of the following is/are contained:
25-100 100 kg/m³ silica dust or silica slurry,
3-6 wt % plasticizer, and
1 to 5 wt % photocatalytically active material
in each case in terms of the cement weight.

28. Texturizing element according to claim 21, wherein the texturizing element consists of ceramic.

29. Carrier, on which a multitude of texturizing elements according to claim 21 are fixed.

30. Carrier according to claim 29, wherein the carrier is flexible and made of glass, plastic, textile or carbon.

31. Carrier according to claim 29, wherein the carrier is rigid and made of concrete, asphalt, steel or artificial resin.

32. Method for producing traffic surfaces comprising a cover layer, wherein
a cover layer is produced
the cover layer is sanded with texturizing elements according to claim 21, and
the texturizing elements are rolled into, impressed or rubbed into the still plastic cover layer.

33. Method for producing traffic surfaces comprising a cover layer, wherein
a cover layer is produced and
the cover layer is coated by a carrier of texturizing elements according to claim 29.

34. Method for restoring of traffic surfaces comprising a cover layer, wherein
a present cover layer is removed
a new cover layer is produced
the new cover layer is sanded with texturizing elements according to claim 21, and
the texturizing elements are rolled into, impressed or rubbed into the still plastic cover layer.

35. Method for restoring traffic surfaces comprising a cover layer, wherein
a present cover layer is removed
a new cover layer is produced and
the new cover layer is coated with a carrier of texturizing elements according to claim 29.

36. Method according to claim 32, wherein resin asphalt or mastic asphalt is chosen as the cover layer.

37. Method according to claim 32, wherein concrete is chosen as the cover layer.

38. Texturizing element according to claim 22, wherein the distance between two corner points ranges from 4 to 6 mm.

39. Texturizing element according to claim 21, wherein the ratio of arching height to distance between the two corner points ranges from 0.15 to 0.25.

40. Texturizing element according to claim 38, wherein the ratio of arching height to distance between the two corner points ranges from 0.15 to 0.25.

41. Texturizing element according to claim 40, wherein the texturizing element consists of high strength mortar or high strength fine grained concrete.

42. Texturizing element according to claim 41, wherein the mortar or concrete is produced from 500-1000 kg/m³ cement, 1500-2000 kg/m³ rock flour and 125-200 kg/m³ water, with a water cement value from 0.25 to 0.36, and a water binder value from 0.15 to 0.25, and, additionally, one or several of the following is/are contained:
25-100 100 kg/m³ silica dust or silica slurry,
3-6 wt % plastizer, and
1 to 5 wt % photocatalytically active material
in each case in terms of the cement weight.

43. The carrier according to claim 29, wherein the texturizing elements have a distance between two corner points ranging from 4 to 6 mm and the ratio of arching height to distance between the two corner points ranges from 0.15 to 0.25.

44. The carrier according to claim 43, wherein the texturizing elements consist of high strength mortar or high strength fine grained concrete.

45. The carrier according to claim 44, wherein the carrier is flexible and made of glass, plastic, textile or carbon.

46. The method for producing traffic surfaces comprising a cover layer, wherein
a cover layer is produced
the cover layer is sanded with texturizing elements according to a texturizing element for sanding or blunting traffic surfaces having a tetrahedral basic shape having a distance between two corner points of 2 to 10 mm, wherein surfaces of the texturizing element are bent to be concave having a ratio of arching height to distance between two corner points ranging from 0.05 to 0.35, and wherein the texturizing element has a compressive strength of ≦120 MPa determined according to DIN EN 196-1, and
the texturizing elements are rolled into, impressed or rubbed into the still plastic cover layer, wherein the cover layer is sanded with texturizing elements according to claim 40.

47. The method for producing traffic surfaces comprising a cover layer, wherein
a cover layer is produced
the cover layer is sanded with texturizing elements according to a texturizing element for sanding or blunting traffic surfaces having a tetrahedral basic shape having a distance between two corner points of 2 to 10 mm, wherein surfaces of the texturizing element are bent to be concave having a ratio of arching height to distance between two corner points ranging from 0.05 to 0.35, and wherein the texturizing element has a compressive strength of ≦120 MPa determined according to DIN EN 196-1,
wherein the cover layer is sanded with texturizing elements according to claim 41.

48. The method for restoring of traffic surfaces comprising a cover layer, wherein
a present cover layer is removed
a new cover layer is produced
the new cover layer is sanded with texturizing elements according to a texturizing element for sanding or blunting traffic surfaces having a tetrahedral basic shape having a distance between two corner points of 2 to 10 mm, wherein surfaces of the texturizing element are bent to be concave having a ratio of arching height to distance between two corner points ranging from 0.05 to 0.35, and wherein the texturizing element has a compressive strength of ≦120 MPa determined according to DIN EN 196-1, and
the texturizing elements are rolled into, impressed or rubbed into the still plastic cover layer, wherein the cover layer is sanded with texturizing elements according to claim 40.

49. The method for restoring of traffic surfaces comprising a cover layer, wherein
a present cover layer is removed
a new cover layer is produced
the new cover layer is sanded with texturizing elements according to a texturizing element for sanding or blunting traffic surfaces having a tetrahedral basic shape having a distance between two corner points of 2 to 10 mm, wherein surfaces of the texturizing element are bent to be concave having a ratio of arching height to distance between two corner points ranging from 0.05 to 0.35, and wherein the texturizing element has a compressive strength of ≦120 MPa determined according to DIN EN 196-1, and
the texturizing elements are rolled into, impressed or rubbed into the still plastic cover layer, wherein the cover layer is sanded with texturizing elements according to claim 41.

50. The method according to claim 33, wherein the texturizing elements on the carrier have a distance between two corner points ranging from 4 to 6 mm and the ratio of arching height to distance between the two corner points ranges from 0.15 to 0.25.

51. The method according to claim 33, wherein the texturizing elements on the carrier consist of high strength mortar or high strength fine grained concrete.

52. The method according to claim 35, wherein the texturizing elements on the carrier have a distance between two corner points ranging from 4 to 6 mm and the ratio of arching height to distance between the two corner points ranges from 0.15 to 0.25.

53. The method according to claim 35, wherein the texturizing elements on the carrier consist of high strength mortar or high strength fine grained concrete.
